(19) United States
(12) Patent Application Publication
(10) Pub. No.: US 2024/0294798 A1
(43) Pub. Date: Sep. 5, 2024

(54) Coating Agents and Coatings That Are Obtainable Therefrom and Have Improved Resistance to Soiling and (Self-) Cleaning Properties

(71) Applicant: COVESTRO DEUTSCHLAND AG, Leverkusen (DE)

(72) Inventors: Jan Weikard, Leverkusen (DE); Sven Siegemund, Burscheid (DE); Elisavet Papadopoulou, Troisdorf (DE)

(21) Appl. No.: 18/572,238

(22) PCT Filed: Jun. 20, 2022
(86) PCT No.: PCT/EP2022/066776

§ 371 Date: Dec. 20, 2023

(30) Foreign Application Priority Data
Jun. 21, 2021 (EP) 21180677.3

(51) Int. Cl. C09D 175/06; B05D 7/00; C08G 18/12; C08G 18/42; C08G 18/61; C08G 18/62; C08G 18/77; C08G 77/08

(52) U.S. Cl. CPC C09D 175/06; B05D 7/53; C08G 18/12; C08G 18/42; C08G 18/61; C08G 18/6225; C08G 18/778; C08G 77/08; B05D 2503/00

(57) ABSTRACT

The invention relates to coating agents containing polyisocyanates that include amino silane groups and/or mercapto silane groups, further containing a stored mixture of hydroxyl group-containing compounds and alkoxysilyl-functional siloxanes, and catalysts for crosslinking silane groups. Also disclosed are the production of said coating agents and the use thereof for producing coatings on substrates, in particular plastic substrates, e.g. substrates used in the automobile industry.

### CROSS-REFERENCE TO RELATED APPLICATIONS

This application is the United States national phase of International Application No. PCT/EP2022/066776 filed Jun. 20, 2022, and claims priority to European Patent Application No. 21180677.3 filed Jun. 21, 2021, the disclosures of which are hereby incorporated by reference in their entireties.

### BACKGROUND

### Technical Field

The invention relates to coating compositions containing aminosilane- and/or mercaptosilane-comprising polyisocyanates, a stored mixture of hydroxyl-containing compounds and alkoxysilyl-functional siloxanes and catalysts for crosslinking of silane groups, to the production of these coating compositions and to the use thereof for producing coatings on substrates, in particular plastics substrates, such as are found for example in the automotive industry.

### Description of Related Art

It is an object of the present invention to provide novel coating compositions that are to feature very good soiling resistances and (self-)cleaning properties and are in particular to be suitable for coating substrates made of plastics.

This object is achieved by provision of the subsequently more particularly described coating compositions according to the invention which in addition to aminosilane- and/or mercaptosilane-comprising polyisocyanates contain a stored mixture of hydroxyl-containing compounds and alkoxysilyl-functional siloxanes.

WO2017/202692 discloses coating compositions and coatings obtainable therefrom with improved resistance to soiling and (self-)cleaning properties which are obtainable using aminosilane-functionalized isocyanates in conjunction with hydroxyl-containing compounds and alkoxysilyl-functional siloxanes. The use of a stored mixture of hydroxyl-containing compounds and alkoxysilyl-functional siloxanes is not mentioned or rendered obvious.

### SUMMARY

The present invention provides two-component coating compositions composed of a first component (I) containing or consisting of
(A) at least one polyisocyanate component obtainable by reaction of
   (A1) at least one polyisocyanate with
   (A2) at least one isocyanate-reactive compound of general formula (I)

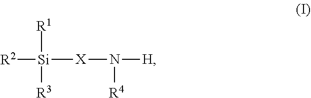

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical which has at least 2 carbon atoms and may optionally contain up to 2 imino groups (—NH—),
R⁴ is hydrogen, a saturated or unsaturated, linear or branched, aliphatic or cycloaliphatic or an optionally substituted aromatic or araliphatic radical having up to 18 carbon atoms or
   i) a radical of formula

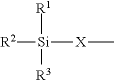

in which R¹, R², R³ and X are as defined above or
ii) a radical of formula

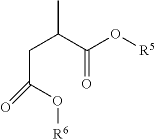

in which R⁵ and R⁶ are independently of one another saturated or unsaturated, linear or branched, aliphatic or cycloaliphatic or aromatic organic radicals having 1 to 18 carbon atoms, which may be substituted or unsubstituted and/or have heteroatoms in the chain, or
iii) a radical of formula

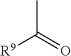

in which R⁹ is hydrogen or a saturated linear or branched, aliphatic or
cycloaliphatic organic radical having 1 to 8 carbon atoms, or of general formula (II)

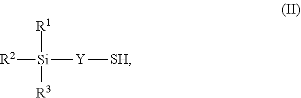

in which R¹, R² and R³ are as defined above for formula (I) and
Y is a linear or branched organic radical having at least 2 carbon atoms,
(B) optionally one or more catalysts for the crosslinking of silane groups and a second component (II) containing or consisting of
(C) at least one hydroxyl-containing compound,
(D) at least one alkoxysilyl-functional siloxane of formula (III)

R¹⁰—SiR¹¹₂-Aₓ-B_{y}—O—SiR¹²₂-R¹³ (III),
wherein A is an —[O—SiR¹⁴₂]— group and B is an —[O—SiR¹⁵R¹⁶]— group,
R¹¹, R¹², R¹⁴ and R¹⁵ are independently of one another linear or branched alkyl groups having 1 to 4 carbon atoms,
R¹⁰, R¹³ and R¹⁶ are independently of one another an -L-R¹⁷ group, wherein
L=a linear or branched 2-valent alkyl group and
R¹⁷═H or —Si(R¹⁸)_{z}(OR¹⁹)_{3-z} where R¹⁸, R¹⁹=a linear or branched alkyl group having 1 to 4 carbon atoms and z=0, 1 or 2, preferably z=0,
with the proviso that at least one of the radicals R¹⁰ or R¹³ and/or at least one
group B includes a group R¹⁷═—Si(R¹⁸)_{z}(OR¹⁹)_{3-z},
x is independently at each occurrence an integer of 1-20 and
y is independently at each occurrence an integer of 0-10,
wherein preferably x+y≤20,
and
(B′) optionally one or more catalysts for the crosslinking of silane groups,
wherein component II is obtained by storing a mixture of C and D for at least (≥) 5 hours and
wherein at least one of the two components I and II contains at least one catalyst for the crosslinking of silane groups (B or B′) and B′, if present in component II, is already present in the mixture of C and D at commencement of storage thereof or is admixed with the mixture of C and D during storage thereof or a portion of B′ is already present in the mixture of C and D at commencement of storage thereof and a further portion is admixed during storage of the mixture.

### DETAILED DESCRIPTION

### Polyisocyanate Component a

### Polyisocyanate A1

Suitable starting compounds A1 for producing the polyisocyanate component A include any desired monomeric diisocyanates having aliphatically, cycloaliphatically, araliphatically and/or aromatically bonded isocyanate groups which may be produced by any desired processes, for example by phosgenation or by a phosgene-free route, for example by urethane cleavage.

Suitable monomeric diisocyanates include for example those of general formula (IV)

OCN—Z—NCO (IV),

in which Z is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 5 to 18 carbon atoms, for example 1,4-diisocyanatobutane, 1,5-diisocyanatopentane (PDI), 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diiisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate and any desired mixtures of these isomers, diphenylmethane 2,4′- and/or 4,4′-diisocyanate and naphthylene 1,5-diisocyanate and any desired mixtures of such diisocyanates. Further diisocyanates which are likewise suitable are found, furthermore, for example, in Justus Liebigs Annalen der Chemie Volume 562 (1949) pp. 75-136.

Particular preference is given to monomeric diisocyanates of general formula (IV) in which Z is a linear or branched, aliphatic or cycloaliphatic radical having 5 to 13 carbon atoms.

Very particularly preferred monomeric diisocyanates for producing polyisocyanate component A are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

In addition to the abovementioned monomeric diisocyanates suitable starting compounds A1 for producing the polyisocyanate component A further include any desired oligomeric di- and polyisocyanates with uretdione, isocyanurate, urethane, allophanate, thiourethane, thioallophanate, biuret, urea, iminooxadiazinedione and/or oxadiazinetrione structures obtainable by modifying monomeric aliphatic, cycloaliphatic, araliphatic and/or aromatic diisocyanates or any mixtures of these oligomeric di- and polyisocyanates. Production of these oligomeric compounds is carried out according to methods for isocyanate oligomerization known per se, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299 and in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915 and JP 56059828. Suitable monomeric diisocyanates include for example the abovementioned diisocyanates. The abovementioned preferred ranges apply here.

### Isocyanate-Reactive Compounds A2

Suitable starting compounds A2 for producing the polyisocyanate component A are for example aminosilanes of general formula (I)

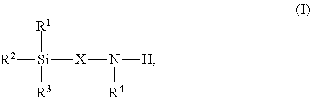

in which
R¹, R² and R³ are identical or different radicals and are each a saturated or unsaturated, linear or branched, aliphatic or cycloaliphatic radical or an optionally substituted aromatic or araliphatic radical which has up to 18 carbon atoms and may optionally contain up to 3 heteroatoms from the series of oxygen, sulfur and nitrogen,
X is a linear or branched organic radical which has at least 2 carbon atoms and may optionally contain up to 2 imino groups (—NH—),
and
R⁴ is hydrogen, a saturated or unsaturated, linear or branched, aliphatic or cycloaliphatic radical or an optionally substituted aromatic or araliphatic radical having up to 18 carbon atoms or
   i) a radical of formula

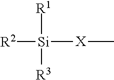

in which R¹, R², R³ and X are as defined above or
ii) a radical of formula

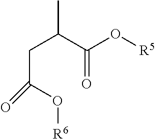

in which R⁵ and R⁶ are independently of one another saturated or unsaturated, linear or branched, aliphatic or cycloaliphatic or aromatic organic radicals having 1 to 18 carbon atoms, which may be substituted or unsubstituted and/or have heteroatoms in the chain, or
iii) a radical of formula

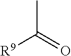

in which R⁹ is hydrogen or a saturated linear or branched, aliphatic or cycloaliphatic organic radical having 1 to 8 carbon atoms,

Suitable aminosilanes of general formula (I) are for example 3-aminopropyltrimethoxysilane, 3-aminopropyltriethoxysilane, 3-aminopropylmethyldimethoxysilane, 3-aminopropylmethyldiethoxysilane, 3-aminopropylethyldiethoxysilane, 3-aminopropyldimethylethoxysilane, 3-aminopropyldiisopropylethoxysilane, 3-aminopropyltripropoxysilane, 3-aminopropyltributoxysilane, 3-aminopropylphenyldiethoxysilane, 3-aminopropylphenyldimethoxysilane, 3-aminopropyltris(methoxyethoxyethoxy)silane, 2-aminoisopropyltrimethoxysilane, 4-aminobutyltrimethoxysilane, 4-aminobutyltriethoxysilane, 4-aminobutylmethyldimethoxysilane, 4-aminobutylmethyldiethoxysilane, 4-aminobutylethyldimethoxysilane, 4-aminobutylethyldiethoxysilane, 4-aminobutyldimethylmethoxysilane, 4-aminobutylphenyldimethoxysilane, 4-aminobutylphenyldiethoxysilane, 4-amino(3-methylbutyl)methyldimethoxysilane, 4-amino(3-methylbutyl)methyldiethoxysilane, 4-amino(3-methylbutyl)trimethoxysilane, 3-aminopropylphenylmethyl-n-propoxysilane, 3-aminopropylmethyldibutoxysilane, 3-aminopropyldiethylmethylsilane, 3-aminopropylmethylbis(trimethylsiloxy)silane, 11-aminoundecyltrimethoxysilane, N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, N-(2-aminoethyl)-3-aminopropyltrimethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropyltris(2-ethylhexoxy)silane, N-(6-aminohexyl)-3-aminopropyltrimethoxysilane, N-benzyl-N-(2-aminoethyl)-3-aminopropyltrimethoxysilane, bis(3-trimethoxysilylpropyl)amine, bis(3-triethoxysilylpropyl)amine, (aminoethylaminomethyl)phenethyltrimethoxysilane, N-vinylbenzyl-N-(2-aminoethyl)-3-aminopropylpolysiloxane, N-vinylbenzyl-N-(2-aminoethyl)-3-aminopropylpolysiloxane, 3-ureidopropyltriethoxysilane, 3-(m-aminophenoxy)propyltrimethoxysilane, m- and/or p-aminophenyltrimethoxysilane, 3-(3-aminopropoxy)-3,3-dimethyl-1-propenyltrimethoxysilane, 3-aminopropylmethylbis(trimethylsiloxy)silane, 3-aminopropyltris(trimethylsiloxy)silane, 3-aminopropylpentamethyldisiloxane or any desired mixture of such aminosilanes.

Preferred among these are aminosilanes of general formula (I), in which
R¹, R² and R³ are each alkyl radicals having up to 6 carbon atoms and/or alkoxy radicals containing up to 3 oxygen atoms with the proviso that at least one of the radicals R¹, R² and R³ is an alkoxy radical of this kind,
X is a linear or branched organic radical having at least 2 carbon atoms and
R⁴ is a saturated, linear or branched, aliphatic or cycloaliphatic radical having up to 6 carbon atoms or a radical of formula

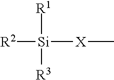

in which R¹, R², R³ and X have the definition given above.

Particularly preferred among these are aminosilanes of general formula (I), in which
R¹, R² and R³ are each methyl, methoxy and/or ethoxy, with the proviso that at least one of the radicals
R¹, R² and R³ is a methoxy or ethoxy radical,
X is a propylene radical (—CH₂—CH₂—CH₂—), and
R⁴ is a linear alkyl radical having up to 4 carbon atoms or a radical of formula

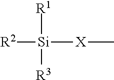

in which R¹, R², R³ and X are as defined above.

Very particularly preferred among these are N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, bis(3-trimethoxysilylpropyl)amine and/or bis(3-triethoxysilylpropyl)amine.

Preferred aminosilanes of general formula (I) further include for example those in which
R⁴ is a radical of formula

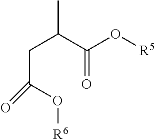

in which
R¹, R² and R³ are each alkyl radicals having up to 6 carbon atoms and/or alkoxy radicals containing up to 3 oxygen atoms with the proviso that at least one of the radicals R¹, R² and R³ is an alkoxy radical of this kind,
X is a linear or branched organic radical having at least 2 carbon atoms and
R⁵ and R⁶ independently of one another are saturated or unsaturated, linear or branched, aliphatic or cycloaliphatic or aromatic organic radicals which have 1 to 18 carbon atoms, are substituted or unsubstituted and/or have heteroatoms in the chain.

Particularly preferred among these are aminosilanes of general formula (I) in which
R⁴ is a radical of formula

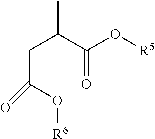

in which
R¹, R² and R³ are each methyl, methoxy and/or ethoxy, with the proviso that at least one of the radicals R, R² and R³ is a methoxy or ethoxy radical,
X is a propylene radical (—CH₂—CH₂—CH₂—) and
R⁵ and R⁶ are independently of one another a methyl, ethyl, n-butyl or 2-ethylhexyl radical.

These aminosilanes are the known silane-functional aspartic esters, such as are obtainable according to the teaching of EP-A 0 596 360 by reacting aminosilanes bearing primary amino groups with fumaric esters and/or maleic esters.

Suitable starting compounds for producing these silane-functional aspartic esters are therefore in principle any desired aminosilanes of general formula (I)

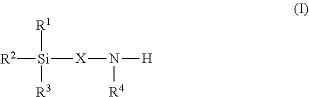

in which R¹, R², R³ and X are as defined above for formula (I) and R⁴ is hydrogen.

These are reacted with fumaric diesters and/or maleic diesters of general formula (V)

R⁵OOC—CH═CH—COOR⁶ (V)

in which the radicals R⁵ and R⁶ are as defined above.

Very particularly preferred silane-functional aspartic acid esters are reaction products of 3-aminopropyltrimethoxysilane and/or 3-aminopropyltriethoxysilane with diethyl maleate.

Preferred aminosilanes of general formula (I) further include those in which
R⁴ is a radical of formula

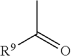

in which
R¹, R² and R³ are each alkyl radicals having up to 6 carbon atoms and/or alkoxy radicals which contain up to 3 oxygen atoms, with the proviso that at least one of the radicals R¹, R² and R³ is an alkoxy radical of this kind,
X is a linear or branched organic radical having at least 2 carbon atoms and
R⁹ is hydrogen or a saturated linear or branched, aliphatic or cycloaliphatic organic radical having 1 to 8 carbon atoms.

Particularly preferred among these are aminosilanes of general formula (I) in which
R⁴ is a radical of formula

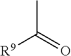

in which
R¹, R² and R³ are each methyl, methoxy and/or ethoxy, with the proviso that at least one of the radicals R¹, R² and R³ is a methoxy or ethoxy radical,
X is a propylene radical (—CH₂—CH₂—CH₂—), and
R⁹ represents hydrogen.

These aminosilane are the known silane-functional alkylamides as obtainable, for example, by the processes disclosed in U.S. Pat. Nos. 4,788,310 and 4,826,915 by reacting aminosilanes bearing primary amino groups with alkyl alkylcarboxylates to eliminate alcohol.

Suitable starting compounds for producing silane-functional alkylamides are therefore in principle any desired aminosilanes of general formula (I)

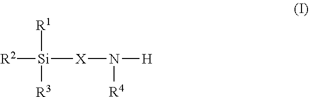

in which R¹, R², R³ and X are as defined above for formula (I) and R⁴ is hydrogen.

These are reacted with alkyl alkylcarboxylates of the general formula (VI)

R⁹—COOR²⁰ (VI),
in which
R⁹ is as defined above and
R²⁰ is a saturated aliphatic organic radical having 1 to 4 carbon atoms.

Very particularly preferred silane-functional alkylamides are reaction products of 3-aminopropyltrimethoxysilane and/or 3-aminopropyltriethoxysilane with methyl formate and/or ethyl formate.

Suitable starting compounds A2 for producing the polyisocyanate component A also include mercaptosilanes of general formula (II)

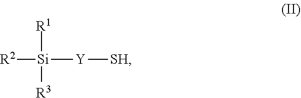

in which R¹, R² and R³ are as defined above for formula (I) and
Y is a linear or branched organic radical having at least 2 carbon atoms.

Suitable mercaptosilanes A2 are for example 2-mercaptoethyltrimethylsilane, 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropyltriethoxysilane, 3-mercaptopropylethyldimethoxysilane, 3-mercaptopropylethyldiethoxysilane and/or 4-mercaptobutyltrimethoxysilane.

Preferred mercaptosilanes A2 for the process according to the invention are those of general formula (II) in which
R¹, R² and R³ are identical or different radicals and are each a saturated, linear or branched, aliphatic or cycloaliphatic radical having up to 6 carbon atoms, and may optionally contain up to 3 oxygen atoms, and
Y is a linear or branched alkylene radical having 2 to 10 carbon atoms.

Particularly preferred mercaptosilanes A2 are those of general formula (II) in which
R¹, R² and R³ are each alkyl radicals having up to 6 carbon atoms and/or alkoxy radicals which contain up to 3 oxygen atoms, with the proviso that at least one of the radicals R¹, R² and R³ is an alkoxy radical of this kind, and
Y is a propylene radical (—CH₂—CH₂—CH₂—).

Very particularly preferred mercaptosilanes A2 are those of general formula (II) in which
R¹, R² and R³ are identical or different radicals and are each methyl, methoxy or ethoxy, with the proviso that at least one of the radicals R¹, R² and R³ is a methoxy or ethoxy radical, and
X is a propylene radical (—CH₂—CH₂—CH₂—), especially 3-mercaptopropyltrimethoxysilane and/or 3-mercaptopropyltriethoxysilane.

To produce the polyisocyanate component A the polyisocyanates A1 are reacted with the isocyanate-reactive compounds A2 at temperatures of 20° C. to 200° C., preferably 30° C. to 160° C.

Production is preferably carried out while maintaining an equivalent ratio of isocyanate groups to isocyanate-reactive groups of 50:1 to 1.05:1, preferably of 30:1 to 1.25:1, particularly preferably 20:1 to 1.5:1.

Production of the polyisocyanate component A may be performed solventlessly. If desired, however, suitable solvents inert toward the reactive groups of the starting components can also be used. Examples of suitable solvents are the customary coatings solvents which are known per se, such as, for example, ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, relatively highly substituted aromatics, of the kind commercialized, for example, under the names solvent naphtha, Solvesso®, Isopar®, Nappar® (Deutsche EXXON CHEMICAL GmbH, Cologne, DE) and Shellsol® (Deutsche Shell Chemie GmbH, Eschborn, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

The reaction of the starting components A1 and A2 may be performed with or without the use of catalysts. However, especially when using mercaptosilanes (formula II) it may be advantageous to additionally employ suitable catalysts for accelerating the SH—NCO reaction which leads to the formation of thiourethane and/or thioallophanate structures. Suitable catalysts especially include the customary urethanization and allophanatization catalysts known from polyurethane chemistry.

Examples here include tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,2-dimethylimidazole, 2-methylimidazole, N,N-dimethylimidazole-β-phenylethylamine, 1,4-diazabicyclo [2.2.2]octane (DABCO) and bis(N,N-dimethylaminoethyl) adipate, amidines, for example 1,5-diazabicyclo[4.3.0]nonene (DBN), 1,8-diazabicyclo[5.4.0]undec-7-ene (DBU) and 2,3-dimethyl-3,4,5,6-tetrahydropyrimidine, alkanolamine compounds, for example triethanolamine, triisopropanolamine, N-methyldiethanolamine, N-ethyldiethanolamine, dimethylaminoethanol and 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine, bis(dimethylaminoethyl) ether and metal salts, for example inorganic and/or organic compounds of iron, lead, bismuth, zinc and/or tin in customary oxidation states of the metal, for example iron(II) chloride, iron(III) chloride, bismuth(III) bismuth(III) 2-ethylhexanoate, bismuth(III) octoate, bismuth(III) neodecanoate, zinc chloride, zinc 2-ethylcaproate, zinc(II) stearate, zinc(II) n-octanoate, zinc(II) 2-ethyl-1-hexanoate, zinc(II) naphthenate or zinc(II) acetylacetonate, tin(II) octoate, tin(II) ethylcaproate, tin(II) palmitate, tin(II) laurate, dibutyltin(IV) dilaurate (DBTL), dibutyltin(IV) dichloride, tin(II) 2-ethyl-1-hexanoate, dibutyltin oxide, dibutyltin diacetate, dibutyltin dimaleate or dioctyltin diacetate, lead octoate, zirconium compounds, for example zirconium(IV) 2-ethyl-1-hexanoate, zirconium(IV) neodecanoate, zirconium(IV) naphthenate or zirconium(IV) acetylacetonate, aluminum tri(ethylacetoacetate), potassium octoate, manganese, cobalt or nickel compounds and strong acids, for example trifluoroacetic acid, sulfuric acid, hydrogen chloride, hydrogen bromide, phosphoric acid or perchloric acid or any desired mixtures of these catalysts.

Catalysts preferred for use for accelerating the thiourethanization reaction are tertiary amines, amidines and tin compounds of the recited type. Particular preference is given to 1,4-diazabicyclo-(2,2,2)-octane (DABCO), 1,5-diazabicyclo[4.3.0]nonene (DBN), 1,8-diazabicyclo(5.4.0)undec-7ene (DBU) and dibutyltin(IV) dilaurate (DBTL) or any desired mixtures of these catalysts.

When catalysts are used for accelerating the thiourethanization reaction these are employed in amounts of 0.001% to 1.0% by weight, preferably 0.01% to 0.5% by weight, calculated as the total amount of employed catalysts based on the total amount of employed polyisocyanates A1 and mercaptosilanes A2.

Catalysts preferred for use for accelerating the thioallophanatization reaction are zinc and zirconium compounds of the abovementioned type. Very particular preference is given to zinc(II) n-octanoate, zinc(II) 2-ethyl-1-hexanoate and/or zinc(II) stearate, zirconium(IV) n-octanoate, zirconium(IV) 2-ethyl-1-hexanoate and/or zirconium(IV) neodecanoate or any desired mixtures of these catalysts.

When catalysts are used for accelerating the thioallophanatization reaction these are employed in amounts of 0.001% to 5% by weight, preferably 0.005% to 1% by weight, calculated as the total amount of employed catalysts based on the total amount of employed polyisocyanates A1 and mercaptosilanes A2.

Detailed synthesis routes for synthesis of polyisocyanate components according to A based on the reaction of mercaptosilanes according to formula II (A2) with polyisocyanates according to component A1 to form thiourethane structures and thioallophanate structures are described in EP-B 2892905 and WO15/189164 respectively which are hereby incorporated by reference.

In a preferred embodiment the at least one polyisocyanate component A has thioallophanate structures.

In a particularly preferred embodiment the at least one polyisocyanate component A has thioallophanate structures based on the reaction of monomeric aliphatic diisocyanate with a mercaptosilane of formula II.

In a very particularly preferred embodiment the monomeric aliphatic diisocyanate is PDI and/or HDI. In an alternative very particularly preferred embodiment the mercaptosilane is mercaptopropyltrimethoxysilane. It is most preferable when the monomeric diisocyanate employed is HDI and the mercaptosilane employed is mercaptopropyltrimethoxysilane.

The polyisocyanate components A preferably have an NCO content of 1.3% to 24.9% by weight, particularly preferably of 4.0% to 23.5% by weight, very particularly preferably of 5.0% to 21.0% by weight, and preferably have an average NCO functionality of 1.0 to 4.9, particularly preferably of 1.8 to 4.8, very particularly preferably of 2.0 to 4.0.

### Catalysts for Crosslinking Silane Groups B and B′

The coating compositions of the invention preferably contain at least one catalyst for crosslinking silane groups. This may be present in the first or the second coating composition component or in both coating composition components. In the latter case both components may contain the same/the same or different components.

These catalysts are any desired compounds which are capable of accelerating the hydrolysis and condensation of alkoxysilane groups or preferably the thermally induced silane condensation.

Suitable catalysts B/B′ are for example acids, for example organic carboxylic acids, sulfuric acid, p-toluenesulfonic acid, trifluoromethanesulfonic acid, dodecylbenzenesulfonic acid, acetic acid, trifluoroacetic acid, phosphoric monoesters and phosphoric diesters, such as dibutyl phosphate, 2-ethylhexyl phosphate, phenyl phosphate and bis(2-ethylhexyl) phosphate, and also phosphonic diesters and diphosphonic diesters, as described for example in WO 2007/033786.

Suitable catalysts B/B′ likewise include bases, for example the N-substituted amidines 1,5-diazabicyclo[4.3.0]non-5-ene (DBN) and 1,5-diazabicyclo[5.4.0]undec-7-ene (DBU), or else metal salts and metal chelates, for example tetraisopropyl titanate, tetrabutyl titanate, titanium(IV) acetylacetonate, aluminum tri-sec-butoxide, aluminum acetylacetonate, aluminum triflate, tin triflate or zirconium ethylacetoacetate such as are described for example in WO 2006/042658.

Suitable catalysts B/B′ likewise include phosphoric esters and phosphonic esters of the abovementioned type that are present in amine-blocked, preferably tertiary amine-blocked, form. Particularly preferred catalysts of this type are those which release the acidic phosphoric and phosphonic esters again in the temperature range of the curing of automotive topcoats and clearcoats, as for example in the range from 100 to 150° C., with elimination of the blocking amine, said esters representing the actually active catalysts. Suitable amine-blocked phosphoric acid catalysts B/B′ are described for example in WO 2008/074489 and WO 2009/077180.

Suitable catalysts B/B′ likewise include organic sulfonic acids of the abovementioned type which are used in blocked form, for example in amine-neutralized form, or as an adduct with epoxides, as described in DE 2 356 768 B1, and which re-release the catalytically active sulfonic acids above 100° C.

Catalysts B/B′ suitable for crosslinking silane groups further include tetraalkylammonium carboxylates, for example tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and/or tetrabutylammonium benzoate.

Catalysts B/B′ suitable for crosslinking silane groups further include quaternary ammonium and phosphonium polyfluorides, such as are known for example as trimerization catalysts for isocyanate groups from EP-A0 798 299, EP-A0 896 009 and EP-A0 962 455.

Suitable catalysts B/B′ finally also include zinc-amidine complexes producible by reaction of one or more zinc(II) biscarboxylates with amidines by the process of WO 2014/016019.

Preferred catalysts B/B′ for crosslinking silane groups are acidic phosphoric esters, phosphonic esters and sulfonic esters of the recited type, which may optionally be present in amine-blocked form, and also tetraalkylammonium carboxylates of the recited type. Particularly preferred catalysts B/B′ are amine-blocked phosphoric esters and sulfonic acids and also the recited tetraalkylammonium carboxylates. Very particularly preferred catalysts B/B′ are amine-blocked phenyl phosphate and bis(2-ethylhexyl) phosphate, tetraethylammonium benzoate and tetrabutylammonium benzoate.

The catalysts B/B′ are employed in the coating compositions according to the invention in amounts of 0.005% by weight up to 5% by weight, preferably of 0.005% by weight to 2% by weight, particularly preferably of 0.005% by weight to 1% by weight, calculated as the sum of all employed catalysts B/B′ and based on the total amount of poliscocyanate component A, hydroxyl-containing component C and siloxane component D.

### Hydroxyl-Containing Compounds C

The hydroxyl-containing compounds C employed are any desired polyols bearing at least two hydroxyl groups. Suitable hydroxyl-containing compounds C are for example the customary polyhydroxyl compounds known from polyurethane chemistry, for example polyester polyols, polyether polyols, polycarbonate polyols and/or polyacrylate polyols or any desired admixtures of such polyols.

Suitable polyester polyols C are for example those having an average molecular weight, calculable from functionality and hydroxyl number, of 200 to 3000, preferably of 250 to 2500, having a hydroxyl group content of 1% to 21% by weight, preferably 2% to 18% by weight, of the kind producible in a manner known per se by reaction of polyhydric alcohols with deficit amounts of polybasic carboxylic acids, corresponding carboxylic anhydrides, corresponding polycarboxylic esters of lower alcohols, or lactones.

Polyhydric alcohols suitable for preparing these polyester polyols are, in particular, those of the molecular weight range 62 to 400, such as, for example, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate.

The acids or acid derivatives used for producing the polyester polyols C may be aliphatic, cycloaliphatic and/or heteroaromatic in nature and may optionally be substituted, for example by halogen atoms, and/or unsaturated. Examples of suitable acids are, for example, polybasic carboxylic acids of the molecular weight range 118 to 300 or derivatives thereof such as, for example, succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bisglycol terephthalate.

Production of the polyester polyols C may also employ any desired mixtures of these starting compounds recited by way of example.

Suitable polyester polyols C also include those producible by ring opening in a manner known per se from lactones and simple polyhydric alcohols, for example those mentioned by way of example hereinabove, as starter molecules. Examples of suitable lactones for producing these polyester polyols A1) are for example β-propiolactone, γ-butyrolactone, γ- and δ-valerolactone, ε-caprolactone, 3,5,5- and 3,3,5-trimethylcaprolactone or any desired mixtures of such lactones.

The production of these lactone polyesters is generally carried out in the presence of catalysts, for example Lewis or Brønsted acids, organotin or organotitanium compounds, at temperatures of 20° C. to 200° C., preferably 50° C. to 160° C.

Suitable polyether polyols C are for example those having an average molecular weight, calculable from functionality and hydroxyl number, of 200 to 6000, preferably 250 to 4000, having a hydroxyl group content of 0.6% to 34% by weight, preferably 1% to 27% by weight, as obtainable in a manner known per se by alkoxylation of suitable starter molecules. Production of these polyether polyols may employ any desired polyhydric alcohols, for example those having a molecular weight of 62 to 400, such as are described above in the production of polyester polyols, as starter molecules.

Alkylene oxides suitable for the alkoxylation reaction especially include ethylene oxide and propylene oxide and these may be employed in the alkoxylation reaction in any desired sequence or else in admixture.

Suitable polyacrylate polyols C are, for example, those having an average molecular weight, calculable from functionality and hydroxyl number or determinable by gel permeation chromatography (GPC), of 800 to 50 000, preferably of 1000 to 20 000, having a hydroxyl group content of 0.1% to 12% by weight, preferably 1 to 10, as producible in a manner known per se by copolymerization of olefinically unsaturated monomers containing hydroxyl groups with hydroxyl-free olefinic monomers.

Examples of suitable monomers for producing the polyacrylate polyols C are vinyl and vinylidene monomers such as, for example, styrene, α-methylstyrene, o- and/or p-chlorostyrene, o-, m- or p-methylstyrene, p-tert-butylstyrene, acrylic acid, acrylonitrile, methacrylonitrile, acrylic and methacrylic esters of alcohols having up to 18 carbon atoms, such as methyl acrylate, ethyl acrylate, n-propyl acrylate, isopropyl acrylate, n-butyl acrylate, isobutyl acrylate, tert-butyl acrylate, amyl acrylate, hexyl acrylate, 2-ethylhexyl acrylate, isooctyl acrylate, 3,3,5-trimethylhexyl acrylate, stearyl acrylate, lauryl acrylate, cyclopentyl acrylate, cyclohexyl acrylate, 4-tert-butylcyclohexyl acrylate, isobornyl acrylate, methyl methacrylate, ethyl methacrylate, n-propyl methacrylate, isopropyl methacrylate, butyl methacrylate, isobutyl methacrylate, tert-butyl methacrylate, amyl methacrylate, hexyl methacrylate, 2-ethylhexyl methacrylate, isooctyl methacrylate, 3,3,5-trimethylhexyl methacrylate, stearyl methacrylate, lauryl methacrylate, cyclopentyl methacrylate, cyclohexyl methacrylate, 4-tert-butylcyclohexyl methacrylate, norbornyl methacrylate or isobornyl methacrylate, diesters of fumaric acid, itaconic acid or maleic acid with alcohols having 4 to 8 carbon atoms, acrylamide, methacrylamide, vinyl esters of alkanemonocarboxylic acids having 2 to 5 carbon atoms, such as vinyl acetate or vinyl propionate, hydroxyalkyl esters of acrylic acid or methacrylic acid having 2 to 5 carbon atoms in the hydroxyalkyl radical, such as 2-hydroxyethyl, 2-hydroxypropyl, 3-hydroxypropyl, 3-hydroxybutyl, 4-hydroxybutyl, trimethylolpropane monoacrylate or monomethacrylate or pentaerythritol monoacrylate or monomethacrylate, and also any desired mixtures of such exemplified monomers.

Preferred hydroxyl-containing compounds C are polyester polyols, polycarbonate polyols and/or polyacrylate polyols of the abovementioned type. Particularly preferred hydroxyl-containing compounds C are polyacrylate polyols of the recited type, which may optionally be employed in admixture with polyester polyols and/or polycarbonate polyols of the recited type. It is very particularly preferable when component C contains exclusively polyacrylate polyols of the recited type.

### Alkoxysilyl-Functional Siloxanes D

The coating compositions according to the invention contain at least one alkoxysilyl-functional siloxane D.

Siloxanes are known to those skilled in the art. What are concerned here are components of general formula R₃Si—[O—SiR₂]ₙ—O—SiR₃, wherein R may be hydrogen atoms or alkyl groups, derived from pure silanes (i.e. binary compounds composed of Si and H). In siloxanes, therefore, the silicon atoms are bonded to their neighboring silicon atom via precisely one oxygen atom and contain at least one Si—O—Si bond. If at least one of the hydrogen atoms is replaced by an organic radical such as for example an alkyl group, the resulting compounds are also referred to as organosiloxanes. Oligomeric or polymeric organosiloxanes (siloxanes where R≠H) have long Si—O main chains and are in turn referred to as silicones.

If the above-described organic radical of the organosiloxane additionally contains at least one alkoxysilyl group the organic radical thus has at least one hydrogen radical substituted by an alkoxysilyl group, as a result of which a hydrogen of the derivative derived from the pure siloxane is thus at least partially substituted by an organic radical which in turn contains an alkoxysilyl-functional group, this is referred to as an alkoxysilyl-functional siloxane (component D) in the context of the present invention.

An alkoxysilyl-functional radical is a functional group deriving from an alkoxysilane, a component deriving from a pure silane and containing an Si—OR group. Accordingly at least one hydrogen atom of a pure silane is substituted by an alkoxy group —OR, i.e. an alkyl group bonded to the silicon via oxygen. Examples include mono-, di- or trimethoxy- or -ethoxysilane.

Accordingly, the alkoxysilyl-functional siloxanes D to be employed according to the invention are derivatives of siloxane in which at least one hydrogen atom has been substituted by an organic radical in which in turn at least one hydrogen radical has been replaced by an alkoxysilyl group. The alkoxysilyl group is thus always to be understood as meaning a functional group of an alkyl group which is itself attached to the siloxane skeleton. The alkoxysilyl group is therefore always connected to the Si—O—Si structure via a divalent organic radical R, for example an alkylene, and never bonds directly to the siloxane backbone of Si—O—Si units.

The alkoxysilyl-functional siloxanes D to be employed according to the invention have the general formula (III):

R¹⁰—SiR¹¹₂-Aₓ-B_{y}—O—SiR¹²₂-R¹³ (III),
wherein A is an —[O—SiR¹⁴₂]— group and B is an —[O—SiR¹⁵R¹⁶]— group,
R¹¹, R¹², R¹⁴ and R¹⁵ are independently of one another linear or branched alkyl groups having 1 to 4 carbon atoms,
R¹⁰, R¹³ and R¹⁶ are independently of one another an -L-R¹⁷ group, wherein
L=a linear or branched 2-valent alkyl group and
R⁷═H or —Si(R¹⁸)_{z}(OR¹⁹)_{3-z} where R¹⁸, R¹⁹=a linear or branched alkyl group having 1 to 4 carbon atoms and z=0, 1 or 2, preferably z=0,
with the proviso that at least one of the radicals includes R¹⁰ or R¹³ and/or at least one group B includes a group R¹⁷═—Si(R¹⁸)_{z}(OR¹⁹)_{3-z},
x is independently at each occurrence an integer of 1-20 and
y is independently at each occurrence an integer of 1-10,
wherein preferably x+y≤20,

The siloxane D thus in any case contains at least one group —Si(R¹⁸)_{z}(OR¹⁹)_{3-z}.

If y>0, the polysiloxane chain contains units A as well as units B. If on the other hand y=0, only units A are present. It is preferable when only units A are present (y=0). It is further preferable when y=0 and x is a number from 6 to 14.

The alkoxysilyl-functional siloxanes D may be linear or branched depending which radicals R¹⁰, R¹³ and/or R¹⁶ contain an alkoxysilyl group. If alkoxysilyl groups in the form of the radical R¹⁷═—Si(R¹⁸)_{z}(OR¹⁹)_{3-z} where R¹⁸, R¹⁹=a linear or branched alkyl group with 1-4 carbon atoms and z=0, 1 or 2, preferably z=0, are arranged in the radicals R¹⁰ and R¹³ only terminally the alkoxysilyl-functional siloxane is linear. However, if alkoxysilyl groups are also present in the radical R¹⁶ the siloxane is branched. The siloxane is preferably linear.

The radicals R¹⁰, R¹³ and R¹⁶ are identical or different radicals, wherein at least one of the radicals is always an -L-R¹⁷ group in which R¹⁷ is an alkoxysilyl group. It is very particularly preferable when at least one of these radicals R¹⁰, R¹³ and R¹⁶ has an -L-R¹⁷ group in which L is an ethylene group and R¹⁷ is a trialkoxysilane group. It is very particularly preferable when L is an ethylene group and R¹⁷ is a trimethoxy- or triethoxysilane group. It is further very particularly preferable when y=0 and both terminal groups R¹⁰ and R¹³ are an -L-R¹⁷ group in which L is an ethylene group and R¹⁷ is a trimethoxy- or triethoxysilane group. In another very particularly preferred embodimenty>0, R¹⁶ is an -L-R¹⁷ group, in which L is an ethylene group and R¹⁷ is a trialkoxysilane group, and R¹⁰ and R¹³ are an -L-R¹⁷ group in which R¹⁷ is a hydrogen atom.

The radicals R¹¹, R¹², R¹⁴, R¹⁵, R¹⁸ and R¹⁹ are particularly preferably identical or different alkyl radicals, these radicals R¹¹, R¹², R¹⁴, R¹⁵, R¹⁸ and R¹⁹ are very particularly preferably linear alkyl groups having one to four carbon atoms and the radicals R¹¹, R¹², R¹⁴, R¹⁵, R¹⁸ and R¹⁹ are further very particularly preferably methyl and/or ethyl radicals, in particular methyl radicals.

Component D contains at least one alkoxysilyl-functional siloxane. Alkoxysilyl-functional siloxanes having the alkoxysilyl function in the side chain may thus be present alongside those in which the alkoxysilyl function(s) are present in the terminal position on the siloxane chain.

Particularly preferred alkoxysilyl-functional siloxanes D are commercially available from Shin Etsu.

It is preferable when the coating compositions according to the invention contain from 0.001% to 5% by weight, preferably from 0.005% to 3% by weight and particularly preferably from 0.01% to 2% by weight, of component E, wherein the reported amounts in % by weight are in each case based on the total amount of polyisocyanate component A, isocyanate-reactive component C and siloxane component D.

### Further Components

### Auxiliary and Additive Substances

The coating compositions according to the invention may optionally comprise further auxiliary and additive substances. These may be present in the first or the second coating composition component or in both coating composition components. In the latter case identical or different auxiliary and additive substances may be present in both components.

If auxiliary and additive substances are present in the second coating composition component these may already be present in the mixture of C and D at commencement of storage thereof or admixed with the mixture of C and D during storage thereof. It is also possible for a portion of the auxiliary and additive substances to already be present in the mixture of C and D at commencement of storage thereof and for a further portion to be admixed during storage of the mixture.

The auxiliary and additive substances are in particular the auxiliary and additive substances known to those skilled in the art from coatings technology, for example solvents, UV stabilizers, antioxidants, water scavengers, leveling agents, rheology additives, slip additives, defoamers, fillers and/or pigments and inorganic nanoparticles, in particular oxides of silicon, aluminum, cerium and/or titanium, which may optionally also be employed in the form of corresponding sols such as advantageously organosols of silicon dioxide.

To reduce the processing viscosity the coating compositions according to the invention may be diluted with customary organic solvents for example. Solvents suitable for this purpose are, for example, the coatings solvents described hereinabove as solvents for optional additional use in the production of the silane-containing polyisocyanates A, these solvents exhibiting chemical inertness to the reactive groups of the coating composition constituents and having a water content of not more than 1.0% by weight, particularly preferably not more than 0.5% by weight, based on employed solvent.

Suitable UV stabilizers can preferably be selected from the group consisting of piperidine derivatives such as 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives such as 2,4-dihydroxybenzophenone, 2-hydroxy-4-methoxybenzophenone, 2-hydroxy-4-octoxybenzophenone, 2-hydroxy-4-dodecyloxybenzophenone or 2,2′-dihydroxy-4-dodecyloxybenzophenone; benzotriazole derivatives such as 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides such as 2-ethyl-2′-ethoxyoxalanilide or 4-methyl-4′-methoxyoxalanilide; salicylic esters such as phenyl salicylate, 4-tert-butylphenyl salicylate, 4-tert-octylphenyl salicylate; cinnamic ester derivatives such as methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred UV stabilizers may be employed either singly or in any desired combinations with one another.

One or more of the UV stabilizers recited by way of example are optionally added to the coating composition according to the invention preferably in amounts of 0.001% to 3.0% by weight, particularly preferably 0.01% to 2% by weight, calculated as the total amount of employed UV stabilizers based on the total amount of polyisocyanate component A, isocyanate-reactive component C, component B and B′ and siloxane component D.

Suitable antioxidants are preferably sterically hindered phenols, which may preferably be selected from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol), and 2,2′-thiodiethyl bis[3-(3,5-di-tert-butyl-4-hydroxyphenyl)propionate]. These may be used as required either individually or in any desired combinations with one another.

These antioxidants are preferably employed in amounts of 0.01% to 3.0% by weight, particularly preferably 0.02% to 2.0% by weight, calculated as the total amount of employed antioxidants based on the total amount of polyisocyanate component A, isocyanate-reactive component C and siloxane component D.

In order to prevent premature crosslinking of the silane groups in the coating compositions according to the invention it may be advantageous to add water scavengers, for example orthoformic esters, for example triethyl orthoformate, or vinylsilanes, for example vinyltrimethoxysilane. These water scavengers are employed, if at all, in amounts of 0.01% by weight to 5% by weight, preferably of 0.01% by weight to 2% by weight, based on the total amount of polyisocyanate component A, isocyanate-reactive component C and siloxane component D.

To improve substrate wetting the coating compositions according to the invention may optionally contain suitable leveling agents, for example organically modified siloxanes, for example polyether-modified siloxanes, polyacrylates and/or fluorosurfactants. These leveling agents are employed, if at all, in amounts of 0.01% by weight to 3% by weight, preferably of 0.01% by weight to 2% by weight, particularly preferably of 0.05% to 1.5% by weight, based on the total amount of polyisocyanate component A, isocyanate-reactive component C and siloxane component D.

The rheology additives, slip additives, defoamers, fillers, matting agents and/or pigments which are likewise optionally present in the coating compositions according to the invention as further auxiliary and additive substances are known to those skilled in the art and are employed, if at all, in the amounts customary in coatings technology. A comprehensive overview of such suitable auxiliary and additive substances may be found for example in Bodo Müller, “Additive kompakt”, Vincentz Network GmbH & Co KG (2009).

Further auxiliary and additive substances that may be added to the coating compositions according to the invention include catalysts suitable for controlling the curing rate, for example the urethanization and allophanatization catalysts customary in isocyanate chemistry, for example tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,2-dimethylimidazole, 2-methylimidazole, N,N-dimethylimidazole-β-phenylethylamine, 1,4-diazabicyclo [2.2.2]octane (DABCO) and bis(N,N-dimethylaminoethyl) adipate, amidines, for example 1,5-diazabicyclo[4.3.0]nonene (DBN), 1,8-diazabicyclo[5.4.0]undec-7-ene (DBU) and 2,3-dimethyl-3,4,5,6-tetrahydropyrimidine, alkanolamine compounds, for example triethanolamine, triisopropanolamine, N-methyldiethanolamine, N-ethyldiethanolamine, dimethylaminoethanol and 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine, bis(dimethylaminoethyl) ether and metal salts, for example inorganic and/or organic compounds of iron, lead, bismuth, zinc and/or tin in customary oxidation states of the metal, for example iron(II) chloride, iron(III) chloride, bismuth(III) bismuth(III) 2-ethylhexanoate, bismuth(III) octoate, bismuth(III) neodecanoate, zinc chloride, zinc 2-ethylcaproate, zinc(II) stearate, zinc(II) n-octanoate, zinc(II) 2-ethyl-1-hexanoate, zinc(II) naphthenate or zinc(II) acetylacetonate, tin(II) octoate, tin(II) ethylcaproate, tin(II) palmitate, tin(II) laurate, dibutyltin(IV) dilaurate (DBTL), dibutyltin(IV) dichloride, tin(II) 2-ethyl-1-hexanoate, dibutyltin oxide, dibutyltin diacetate, dibutyltin dimaleate or dioctyltin diacetate, lead octoate, zirconium compounds, for example zirconium(IV) 2-ethyl-1-hexanoate, zirconium(IV) neodecanoate, zirconium(IV) naphthenate or zirconium(IV) acetylacetonate, aluminum tri(ethylacetoacetate), potassium octoate, manganese, cobalt or nickel compounds and strong acids, for example trifluoroacetic acid, sulfuric acid, hydrogen chloride, hydrogen bromide, phosphoric acid or perchloric acid or any desired mixtures of these catalysts.

### Further Hydrolyzable Silane Compounds

As further components the coating compositions according to the invention may also be admixed with any desired further hydrolyzable silane compounds, such as, for example, tetramethoxysilane, tetraethoxysilane, methyltrimethoxysilane, methyltriethoxysilane, ethyltriethoxysilane, isobutyltrimethoxysilane, isobutyltriethoxysilane, octyltriethoxysilane, octyltrimethoxysilane, (3 glycidyloxypropyl)methyldiethoxysilane, (3-glycidyloxypropyl)trimethoxysilane, phenyltrimethoxysilane or phenyltriethoxysilane, or mixtures of such silane compounds, as coreactants.

These compounds are preferably added to components (I). If they are added to component (II), simple preliminary tests on the specific composition must be carried out to ensure that the stability of component (II) is retained over the desired storage time. Turbidity or an increase in viscosity are signs of insufficient stability for example.

If these hydrolyzable silane compounds are admixed with the coating composition component II these may already be present in the mixture of C and D at commencement of storage thereof or admixed with the mixture of C and D during storage thereof. It is also possible for a portion of these hydrolyzable silane compounds to already be present in the mixture of C and D at commencement of storage thereof and for a further portion to be admixed during storage of the mixture.

### Further Polyisocyanates

In addition to the polyisocyanates A the coating composition component I may also contain further polyisocyanates. These may be for example monomeric or modified polyisocyanates such as were described above under component A1.

In the coating compositions according to the invention the coreactants are typically present in amounts such that there are 0.5 to 3, preferably 0.6 to 2.0, particularly preferably 0.8 to 1.6, isocyanate-reactive groups for each isocyanate group. It is very particularly preferable to establish a ratio of NCO groups to isocyanate-reactive groups of at least 1.0. A most preferred variant employs an excess of NCO groups corresponding to a ratio of NCO groups to isocyanate-reactive groups of 1.05 to 1.50.

The present invention provides a process for producing a coating composition composed of a first component (I) containing or consisting of
(A) at least one polyisocyanate component according to the preceding description
(B) optionally one or more catalysts for the crosslinking of silane groups and a second component (II) containing or consisting of
(C) at least one hydroxyl-containing compound,
(D) at least one alkoxysilyl-functional siloxane (III) according to the preceding description and
(B′) optionally one or more catalysts for the crosslinking of silane groups,

wherein at least one of the two components I and II contains at least one catalyst for the crosslinking of silane groups (B or B′),

characterized in that

the components C and D are fully mixed and after a duration of at least (≥) 5 hours, referred to as storage, the resulting mixture is mixed with component A, optionally in admixture with component B,

wherein B′, if present in component II, is already present in the mixture of C and D at commencement of storage or is admixed with the mixture of C and D during storage thereof or a portion of B′ is already present in the mixture of C and D at commencement of storage thereof and a further portion is admixed during storage of the mixture.

The present invention further provides a coating composition obtainable by the above-described process.

### Storage

As described above, component II is obtained through storage of a mixture of the components C and D for at least (≥) 5 hours, preferably at least 24 hours, particularly preferably at least 48 hours.

Components C and D are added to one another to produce the mixture. Commencement of storage is defined as the time at which the two components have been completely added to one another. While the two substances are added to one another and for a period after complete addition, the mixture is normally stirred to achieve optimal blending of the substances.

Storage terminates at the time at which a first amount of one of the two coating composition components I or II is contacted with the respective other component.

As described above, component II may contain further components, for example the catalyst for the crosslinking of silane groups (B′), auxiliary and additive substances, etc.

As likewise described above, these compounds may already be present in the mixture of C and D or admixed with the mixture of C and D during storage thereof. It is likewise possible for a portion of these compounds to already be present in the mixture of C and D at commencement of storage and a further portion to be admixed during storage of the mixture.

In the cases in which these compounds are completely or partially added during storage the mixture may be stirred again to achieve optimal blending of all components. The time at which storage commences is not delayed by the addition of these compounds.

Storage is preferably carried out under customary storage conditions for coatings of 5° C. to 40° C. Particular preference is given to storage at 15° C. to 25° C., in particular at room temperature (23° C.).

Storage is for at least (≥) 5 hours, preferably at least 24 hours, particularly preferably at least (≥) 48 hours, very particularly preferably at least 72 hours.

Storage at 23° C. is preferably for at least (≥) 5 hours, preferably at least 24 hours, particularly preferably at least (≥) 48 hours, very particularly preferably at least 72 hours.

### Use of the Coating Compositions According to the Invention

Suitable substrates to be coated with the coating compositions according to the invention include any desired substrates such as for example metal, wood, glass, stone, ceramic materials, concrete, rigid and flexible plastics, textiles, leather and paper and composite materials which prior to coating are preferably also provided with one or more layers such as customary primers and/or basecoat layers. In a preferred embodiment the coating compositions according to the invention are used for coating rigid and flexible plastics, in particular for plastics in the automotive industry. The coating compositions according to the invention are preferably employed as clearcoat or topcoat. Particular preference is given to substrates subject to demands such as low soiling characteristics and/or simple cleaning in the case of soiling.

Suitable methods of applying the inventive coating compositions to the substrate are, for example, printing, painting, rolling, curtain-coating, dipping, flowcoating and/or preferably spraying, for example compressed air spraying, airless spraying, high rotation, electrostatic spray application (ESTA), optionally combined with hot spray application, for example hot-air spraying.

Suitable layer thicknesses depend on the application process and are typically between 5 and 60 μm, preferably between 10 and 40 μm, in particular between 12 and 30 μm, based on dry film thickness.

Following application of the coating compositions according to the invention volatile substances such as organic solvents are initially removed using methods customary in coatings technology. Removal is preferably effected by drying at elevated temperatures, for example in a range from 40° C. to 250° C., preferably from 40° C. to 100° C., in ovens and with forced air circulation (convection ovens, jet dryers) and thermal radiation (IR, NIR). It is further possible to employ microwaves. It is possible to combine several of these drying processes.

It is advantageously possible to select the conditions for drying such that the maximum achieved temperature remains below the limit at which the substrate deforms or undergoes other damage.

The invention therefore further relates to the use of the coating compositions according to the invention for the coating of substrates and to the coated substrates themselves

### EXAMPLES

All percentages are based on weight unless otherwise stated.

To produce the solvent-containing clearcoats the polyols Desmophen 670 BA (Covestro Deutschland AG, Leverkusen, DE) and Setalux D A 365 BA/X (Allnex Germany GmbH, Bitterfeld-Wolfen, DE) were mixed to homogeneity with a commercially available leveling additive (Baysilone Lackadditive OL 17, OMG AG+Co. KG, Langenfeld, DE) and the commercially available catalyst Nacure 4000 (King Industries, Norwalk, US, as catalyst C) and, to adjust the viscosity, the solvents methoxypropyl acetate, solvent naphtha 100 and diacetone alcohol were mixed by intensive stirring at room temperature.

In the case of Inventive Example 1 the additive KR-410 (linear alkoxysilyl-functional polysiloxane, Shin-Etsu, Japan) was added to the stock coating mixture, said mixture was mixed to homogeneity and stirred at room temperature for 72 hours. After 72 hours the polyisocyanate was added to this mixture for crosslinking.

In the case of Inventive Example 2 the additive KR-410 (linear alkoxysilyl-functional polysiloxane, Shin-Etsu, Japan) was added to the stock coating mixture, said mixture was mixed to homogeneity and stirred at room temperature for 5 hours. After 5 hours the polyisocyanate was added to this mixture for crosslinking.

In the case of Comparative Example 3 the additive KR-410 (Shin-Etsu, Japan) was incorporated into the stock coating component only shortly before crosslinking and said component was accordingly stored at room temperature for 72 hours without additive. The polyisocyanate was added directly once a homogeneous mixture had been formed.

Table 1 shows the compositions of the individual formulations.

To produce a clearcoat the above-described mixtures were each applied with a spray gun (nozzle: SATA/1.2 mm) onto a glass plate that had been cleaned with isopropyl alcohol. After film application the coating was dried for 10 minutes at room temperature and subsequently for 30 minutes at 80° C. and for 16 hours at 60° C.

König pendulum damping was determined according to DIN EN ISO 1522:2007.

To determine the easy-to-clean properties by the so-called marker test, a broad line was applied to the coating with a commercially available Edding 3000 green permanent marker (Edding, Ahrensburg, Germany) and was wiped off as far as possible after 10 seconds with a dust-free cloth. The intensity of the residue was visually assessed (++=no visible residue, +=slight residue, −=complete line still present). The application behavior was additionally evaluated (O=easy to apply, O/Z=marking contracts slightly, Z=marking contracts markedly).

Measurements of the contact angles with water were performed with an OCA20 device from Data Physics. To this end 10 droplets each containing about 2 μL of distilled water were placed on the coating surface and the resulting contact angle was recorded after about 3 s. The 10 measured values were used to calculate the average. SCA software from Data Physics was used for droplet analysis and evaluation.

Table 2 shows the results of the performance tests in comparison.

### Starting Compounds Used

### Desmophen 670 BA

Lightly-branched, hydroxyl-containing polyester, about 80% in butyl acetate, about 3.5% hydroxyl content, viscosity at 23° C. about 3000 mPas.

### Desmodur 2873

Silane-functional aliphatic polyisocyanate based on HDI (Covestro Deutschland AG, Leverkusen, 100% as supplied, NCO content: 12.3%, viscosity at 23° C.: about 450 mPas.

### Setalux D A 365 BA/X

Polyacrylate polyol (Allnex Germany GmbH, Bitterfeld-Wolfen, DE), 65% solution in butyl acetate/xylene (75:25), about 2.7% hydroxyl content (based on supplied form), viscosity at 23° C.: about 3000 mPas.

### Nacure 4000

Alkyl acid phosphate catalyst (King Industries, Norwalk, US), acid number about 650 mg KOH/g, used as 10% solution of supplied form in MPA.

### KR-410

Linear alkoxysilyl-functional siloxane (Shin-Etsu, Japan), supplied form.

TABLE 1
Clearcoat formulations All figures in g unless stated otherwise.

| Example | 1 | 2 | 3 (comp.) |
|---|---|---|---|
| Component II | | | |
| DESMOPHEN 670 BA | 18.80 | 18.80 | 18.80 |
| Setalux D A 365 BA/X | 130.80 | 130.80 | 130.80 |
| Baysilone Lackadditive OL 17 | 1.80 | 1.80 | 1.80 |
| Methoxypropyl acetate | 36.10 | 36.10 | 36.10 |
| Solvent naphtha 100 | 36.10 | 36.10 | 36.10 |
| Diacetone alcohol: | 18.10 | 18.10 | 18.10 |
| Nacure 4000 | 1.90 | 1.90 | 1.90 |
| KR-410 | 1.70 | 1.70 | 1.70 |
| Storage | 72 h | 5 h | — |
| Component I | | | |
| Desmodur 2873 | 93.20 | 93.20 | 93.20 |

TABLE 2
Overview of test results.

| Example | 1 | 2 | 3 (comp.) |
|---|---|---|---|
| König pendulum damping [s] | 183 | 173 | 172 |
| after 24 h | | | |
| König pendulum damping [s] | 194 | 185 | 188 |
| after 1 week | | | |
| Marker test - residue | ++ | + | + |
| Marker test - application behavior | Z | Z | O/Z |

As is apparent from table 2 the storage of the additive KR-410 in the OH-functional component II brings about marked advantages in the cleaning properties. Even after storage for 5 hours (Example 2) the marking undergoes a more marked contraction than in Comparative Example 3. After storage for 72 hours (Example 1) no residue is apparent after the marker test.

1. A two-component coating composition composed of
a first component (I) containing or consisting of
(A) at least one polyisocyanate component obtainable by reaction of
(A1) at least one polyisocyanate with
(A2) at least one isocyanate-reactive compound of general formula (I) 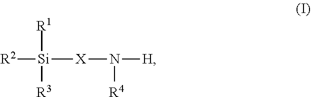
in which
R¹, R² and R³ are identical or different radicals and are each a saturated or unsaturated, linear or branched, aliphatic or cycloaliphatic radical or an optionally substituted aromatic or araliphatic radical having up to 18 carbon atoms, which may optionally contain up to 3 heteroatoms from the series of oxygen, sulfur and nitrogen,
X is a linear or branched organic radical which has at least 2 carbon atoms and may optionally contain up to 2 imino groups (—NH—),
R⁴ is hydrogen, a saturated or unsaturated, linear or branched, aliphatic or cycloaliphatic radical or an optionally substituted aromatic or araliphatic radical having up to 18 carbon atoms or
i) a radical of formula 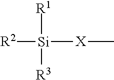
in which R¹, R², R³ and X are as defined above or
ii) a radical of formula 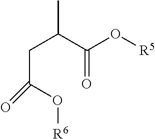
in which R⁵ and R⁶ are independently of one another saturated or unsaturated, linear or branched, aliphatic or cycloaliphatic or aromatic organic radicals having 1 to 18 carbon atoms, which may be substituted or unsubstituted and/or have heteroatoms in the chain, or
iii) a radical of formula 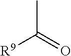
in which R⁹ is hydrogen or a saturated linear or branched, aliphatic or cycloaliphatic organic radical having 1 to 8 carbon atoms,
or of general formula (II) 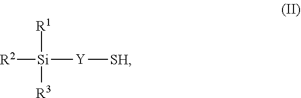
in which R¹, R² and R³ are as defined above for formula (I) and
Y is a linear or branched organic radical having at least 2 carbon atoms,
(B) optionally one or more catalysts for the crosslinking of silane groups, and a second component (II) containing or consisting of
(C) at least one hydroxyl-containing compound,
(D) at least one alkoxysilyl-functional siloxane of formula (III)
R¹⁰—SiR¹¹₂-Aₓ-B_{y}—O—SiR¹²₂-R¹³ (III),
wherein A is an —[O—SiR¹⁴₂]— group and B is an —[O—SiR¹⁵R¹⁶]— group,
R¹¹, R¹², R¹⁴ and R¹⁵ are independently of one another linear or branched alkyl groups having 1 to 4 carbon atoms,
R¹⁰, R¹³ and R¹⁶ are independently of one another an -L-R¹⁷ group-, wherein
L=a linear or branched 2-valent alkyl group and
R¹⁷═H or —Si(R¹⁸)_{z}(OR¹⁹)_{3-z} where R¹⁸, R¹⁹=a linear or branched alkyl group having 1 to 4 carbon atoms and z=0, 1 or 2,
with the proviso that at least one of the radicals includes R¹⁰ or R¹³ and/or at least one group B includes a group R¹⁷═—Si(R¹⁸)_{z}(OR¹⁹)_{3-z},
x is independently at each occurrence an integer of 1-20 and
y is independently at each occurrence an integer of 1-10,
and
(B′) optionally one or more catalysts for the crosslinking of silane groups,
wherein component II is obtained by storing a mixture of C and D for at least (≥) 5 hours and
wherein at least one of the two components I and II contains at least one catalyst for the crosslinking of silane groups (B or B′) and B′, if present in component II, is already present in the mixture of C and D at commencement of storage thereof or is admixed with the mixture of C and D during storage thereof or a portion of B′ is already present in the mixture of C and D at commencement of storage thereof and a further portion is admixed during storage of the mixture.

2. The two-component coating composition as claimed in claim 1, wherein the at least one polyisocyanate A1 is selected from the group consisting of monomeric diisocyanates having aliphatically, cycloaliphatically, araliphatically and/or aromatically bonded isocyanate groups and oligomeric di- or polyisocyanates with uretdione, isocyanurate, urethane, allophanate, thiourethane, thioallophanate, biuret, urea, iminooxadiazinedione and/or oxadiazinetrione structures obtainable by modifying monomeric aliphatic, cycloaliphatic, araliphatic and/or aromatic diisocyanates.

3. The two-component coating composition as claimed in claim 1, wherein the at least one polyisocyanate A1 is selected from the group consisting of HDI, PDI and oligomeric di- or polyisocyanates based on HDI or PDI.

4. The two-component coating composition as claimed in claim 1, wherein the at least one polyisocyanate component A is based on at least one isocyanate-reactive compound of general formula I (A2), in which
i) R¹, R² and R³ are each alkyl radicals having up to 6 carbon atoms and/or alkoxy radicals which contain up to 3 oxygen atoms, with the proviso that at least one of the radicals R¹, R² and R³ is an alkoxy radical of this kind,
X is a linear or branched organic radical having at least 2 carbon atoms, and
R⁴ is a saturated, linear or branched, aliphatic or cycloaliphatic radical having up to 6 carbon atoms or a radical of formula 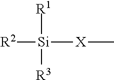
in which R¹, R², R³ and X are as defined above or in which
ii) R¹, R², R³ and X are as defined under i) and
R⁴ is a radical of formula 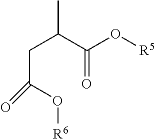
in which
R⁵ and R⁶ are independently of one another a methyl, ethyl, n-butyl or 2-ethylhexyl radical
or in which
iii) R¹, R², R³ and X are as defined under i) and
R⁴ is a radical of formula 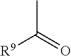
in which
R⁹ is hydrogen or a saturated linear or branched, aliphatic or cycloaliphatic organic radical having 1 to 8 carbon atoms.

5. The two-component coating composition as claimed in claim 1, wherein the at least one polyisocyanate component A is based on at least one isocyanate-reactive compound of general formula II (A2), in which
R¹, R² and R³ are each alkyl radicals having up to 6 carbon atoms and/or alkoxy radicals containing up to 3 oxygen atoms, with the proviso that at least one of the radicals R¹, R² and R³ is an alkoxy radical of this kind, and
Y is a linear or branched alkylene radical having 2 to 10 carbon atoms.

6. The two-component coating composition as claimed in claim 1, wherein to produce the polyisocyanate component A the at least one polyisocyanate A1 is reacted with the at least one isocyanate-reactive compounds A2 at temperatures of 20° C. to 200° C. while maintaining an equivalent ratio of isocyanate groups to isocyanate-reactive groups of 50:1 to 1.05:1.

7. The two-component coating composition as claimed in claim 1, wherein the at least one catalyst for the crosslinking of silane groups (B or B′) is selected from the group consisting of acidic phosphoric esters, phosphonic esters and sulfonic acids, which may optionally be in amine-blocked form, and tetraalkylammonium carboxylates.

8. The two-component coating composition as claimed in claim 1, wherein the at least one hydroxyl-containing compound C is selected from the group consisting of polyester polyols, polyether polyols, polycarbonate polyols and polyacrylate polyols.

9. The two-component coating composition as claimed in claim 1, wherein component II contains at least one alkoxysilyl-functional siloxane D of formula (III), wherein
R¹¹, R¹² and R¹⁴ are independently of one another methyl and/or ethyl,
R¹⁰ and R¹³ are independently of one another an -L-R¹⁷ group, wherein
L=a linear or branched 2-valent alkyl groups, and
R¹⁷═—Si(R¹⁸)_{z}(OR¹⁹)_{3-z} where R¹⁸, R¹⁹=a linear or branched alkyl group having 1 to 4 carbon atoms and
z=0, 1 or 2, and y=0.

10. A process for producing a coating composition composed of
a first component (I) containing or consisting of
(A) at least one polyisocyanate component according to claim 1
(B) optionally one or more catalysts for the crosslinking of silane groups,
and a second component (II) containing or consisting of
(C) at least one hydroxyl-containing compound,
(D) at least one alkoxysilyl-functional siloxane (III)
and
(B′) optionally one or more catalysts for the crosslinking of silane groups,
wherein at least one of the two components I and II contains at least one catalyst for the crosslinking of silane groups (B or B′),
wherein the components C and D are fully mixed and after a duration of at least (≥) 5 hours, referred to as storage, the resulting mixture is mixed with component A, optionally in admixture with component B,
wherein B′, if present in component II, is already present in the mixture of C and D at commencement of storage or is admixed with the mixture of C and D during storage thereof or a portion of B′ is already present in the mixture of C and D at commencement of storage thereof and a further portion is admixed during storage of the mixture.

11. The two-component coating composition as claimed in claim 1, wherein component II is obtained through storage of a mixture of C and D for at least (≥) 24 hours, wherein the mixture of components C and D is mixed with component A, optionally in admixture with component B, after a duration of at least (≥) 24 hours.

12. A process for producing a coating on a substrate, comprising
applying a coating composition obtainable by the process as claimed in claim 10 to a substrate,
thermally curing the coating composition.

13. The process as claimed in claim 12, wherein the coating is a clearcoat or topcoat.

14. The process as claimed in claim 12, wherein the substrate is rigid or flexible plastics.

15. A coated substrate obtainable by a process as claimed in claim 12.

16. The two-component coating composition as claimed in claim 1, wherein x+y≤20.
